(19) United States
(12) Patent Application Publication
(10) Pub. No.: US 2007/0151743 A1
(43) Pub. Date: Jul. 5, 2007

(54) Abrasion resistant coated wire

(76) Inventors: Thomas J. Murray, Chesterfield, MO (US); Philip R. Meister, Belleville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/324,709

(22) Filed: Jan. 3, 2006

(51) Int. Cl. H01B 3/44

(52) U.S. Cl. 174/110 R

(57) ABSTRACT

A coated wire includes an electrical conductor having an abrasion resistant coating. The coating is comprised of an insulating resin with a phosphorus based catalyst. The cured coating demonstrates exceptional techrand scrape and repeated scrape resistance and improved resistance to thermoplastic flow. Unilateral scrape resistance can also be improved using a phosphorus catalyst.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to insulation coatings for electrical conductors; and, more particularly, to an abrasion resistant coating for such conductors.

Coated electrical conductors typically comprise one or more layers of electrical insulation formed around a conductive core. Magnet wire is one form of a coated electrical conductor in which the conductive core is a copper wire, and the insulation layer (or layers) comprise dielectric materials, such as polymeric resins. Magnet wire is used in the electromagnetic windings of transformers, electric motors, and the like. When used in such windings, friction and abrading forces are often encountered with the result that the insulation layer is susceptible to damage.

High voltage-surge failures are a concern of motor manufacturers. These failures have been associated with insulation damage resulting from modern, fast automatic winding and abusive coil insertion processes for motor stators. Coating a polyester insulated wire with an abrasion resistant polyamideimide and a wax is one way to minimize friction and reduce wire surface damage during a winding process. However, wires manufactured this way can experience surge failure rates on the order of 10,000-20,000 parts per million. This is an unacceptability high failure rate. Therefore, a need exists for a wire coating that offers high resistance to the various damaging effects to wire coatings, including abrasion.

The use of phosphorus based catalysts in polyamideimide resin synthesis is known in the art. The process requires the use of stoichiometric amounts of triphenylphosphite (TPP), typically in combination with pyridine, to promote polymerization of aromatic diamines and trimellitic anhydride. Because of the expense involved with the use of such catalysts, this method has never been commercially viable.

One could produce TPP, in-situ, by the addition of a phenol- or a phenolic-like substance to an activated phosphorus compound. Such activated phosphorus compounds would include, for example, species such as phosphorus trichloride or phosphorus tribromide. TPP has been post-added in the extrusion of polyester and polyamide resins. In their article, High-Temperature Reactions of Hydroxyl and Carboxyl PET Chain End Groups in the Presence of Aromatic Phosphite, Aharoni, S. M. et al, Journal of Polymer Science: Part A, Polymer Chemistry Vol. 24, pp. 1281-1296 (1986), the authors added varying levels of TPP to polyethyleneterephthalate (PET) and found an increase in molecular weight compared to a degradation in molecular weight without the catalyst. Similar findings were reported for polyamide resins such as nylon 6,6.

### BRIEF SUMMARY OF THE INVENTION

In accordance with the invention, an electrical conductor is provided with a coating having an abrasion resistant coating system.

In a first embodiment of the invention, the coating includes a phosphorus catalyst dissolved in an insulating resin solution.

In a second embodiment, the coating includes a inorganic or organic particulate material and/or wax dispersed in polyamideimide. The particulate materials that are used include inorganic particles such as alumina, titanium dioxide, silica, boron nitride, or organic particles such as PTFE. Waxes include polyethylene, carnuba, bees wax, as well as other waxes known in the industry. The polyamideimide can be a monolithic coating, or dual coats with another electrical insulation resin being used.

In another embodiment, the coating includes a THEIC polyesterimide coating or a THEIC polyester coating. The polyesterimide or polyester can be a monolithic coating, or dual coats with another electrical insulation resin being used. In a dual coat application, a base coat is applied over the conductive core of the wire, and an outer coat is applied over the base coat. The base coat can be, for example, a polyester resin, such as a THEIC polyester resin. The outer coat can be a polyamideimide resin cross-linked with a phosphorous catalyst.

In yet another embodiment of the invention, the coating includes a polyimide coating which can be a monolithic coating, or dual coats with another electrical insulation resin again being used.

All of the above embodiments may be used as an enamel topcoat or second coating over an insulation coat for the conductor.

Other advantages of the invention will be in part apparent and in part pointed out hereinafter.

### BRIEF DESCRIPTION OF THE DRAWINGS

FIGS. 1-3 are graphs showing the results of the repeated scrape, thermoplastic flow (cut through) and techrand scrape tests for varying amounts of triphenylphosphite added to polyamideimide coatings, polyesterimide (PEI) coatings or polyester (PES) coatings;

FIGS. 4-7 are graphs showing the results of the unilateral scrape, repeated scrape, techrand scrape, and thermoplastic flow (cut through) tests for a coating comprising a top coat and a bottom or base coat in which varying amounts of triphenylphosphite was added the top and base coats; and

FIGS. 8-10 are graphs showing the results of the repeated scrape, thermoplastic flow (cut through) and techrand tests for varying amounts of diphenylphosphite added to polyamideimide coatings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. As various changes could be made to the invention without departing from the scope of the invention, it is intended that all matter contained in the description shall be interpreted as illustrative and not in a limiting sense.

The present invention relates to an electrical conductor having an insulation coating; and more particularly, to an electrical conductor having an abrasion resistant coat system. An abrasion resistant coated magnet wire comprises a coating formed about or around a conductive core which is, for example, a copper or aluminum wire. It will be appreciated, however, that the core may be formed from any suitable ductile conductive material. By way of further example, the core may be formed from copper clad aluminum, silver plated copper, nickel plated copper, aluminum alloy 1350, and combinations of these materials, or other conductive materials.

The coating or enamel is electrically insulative and flexible and is formed from a polyamideimide (PAI), polyesteramideimide, polyesterimide (PEI), polyester (PES) or polyimide binder cross-linked with a phosphite catalyst. The phosphite catalyst can be added to the resin in the range of 0.001 to 10% by weight of the resin. The catalyst can be an aryl, arylalkyl or alkyl phosphorus based catalyst. Arylphosphites, such as a diaryl- or triaryl-phosphite, work well. Phosphines, such as triphenylphosphine and triphenylphosphine sulfide also work. Alkyldiarylphosphites and dialkylarylphosphites should also work. Because of its electrically insulative properties, the coating helps insulate the core as it carries electrical current during use. Because of its flexibility characteristics, the coating is resistant to cracking and/or delaminating, as well as being impact and scrape resistant. The coating substantially improves the wire's toughness so that when it is wound into the windings of an electrodynamic machine (i.e., a motor, generator or the like), the coated wire will not be damaged.

The coating can be applied peripherally about the conductive core in a variety of ways. For example, the coating can be formed from a prefabricated film that is wound around the conductor. Or, the coating can be applied using extrusion coating techniques such as are well-known in the art. Alternatively, the coating can be formed from one or more fluid thermoplastic or thermosetting polymeric resins which are applied to the conductor and dried and/or cured using one or more suitable curing and/or drying techniques such as chemical, radiation, or thermal treatments; such curing and/or drying techniques being known in the art.

### WORKING EXAMPLES AND COMPARISON TESTS

The following working examples were made using 18 gauge control wires with different coating compositions, as noted below, applied to each wire. For example, control wire I comprised a polyamideimide coating; control wire II comprised a polyamideimide coating with alumina particles; and control wire III comprised a polyamideimide coating with polyethylene wax. A phosphorus based catalyst was added in varying percentages (by weight) to the coating composition of each control wire. The wires were tested via a repeated scrape test, a techrand scrape test, and a thermoplastic (cut through) flow test, and the results were compared to each test wires respective control wire.

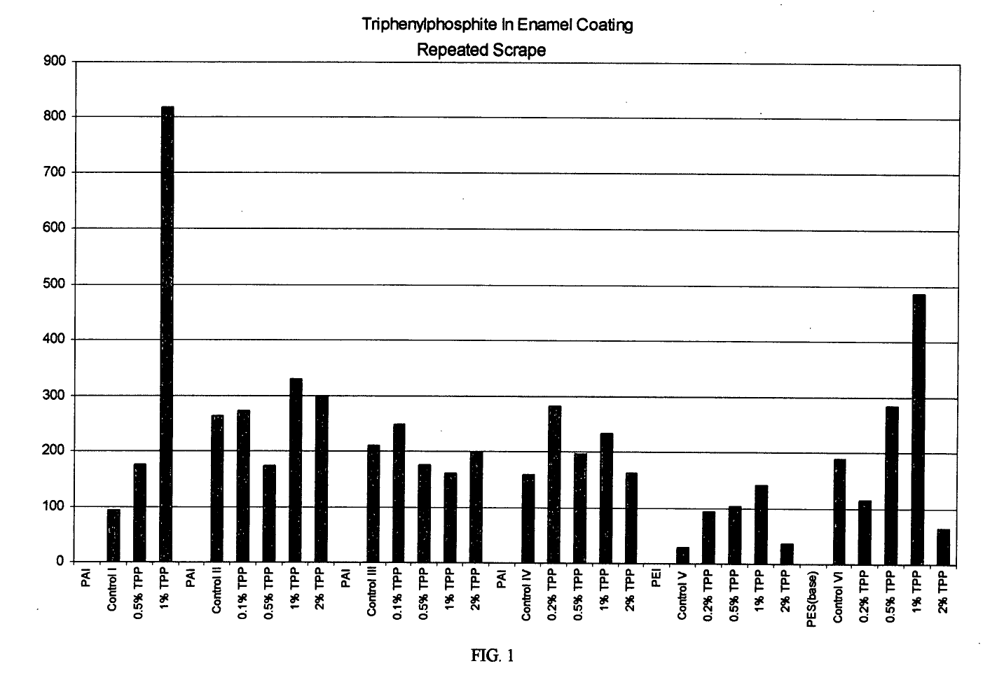

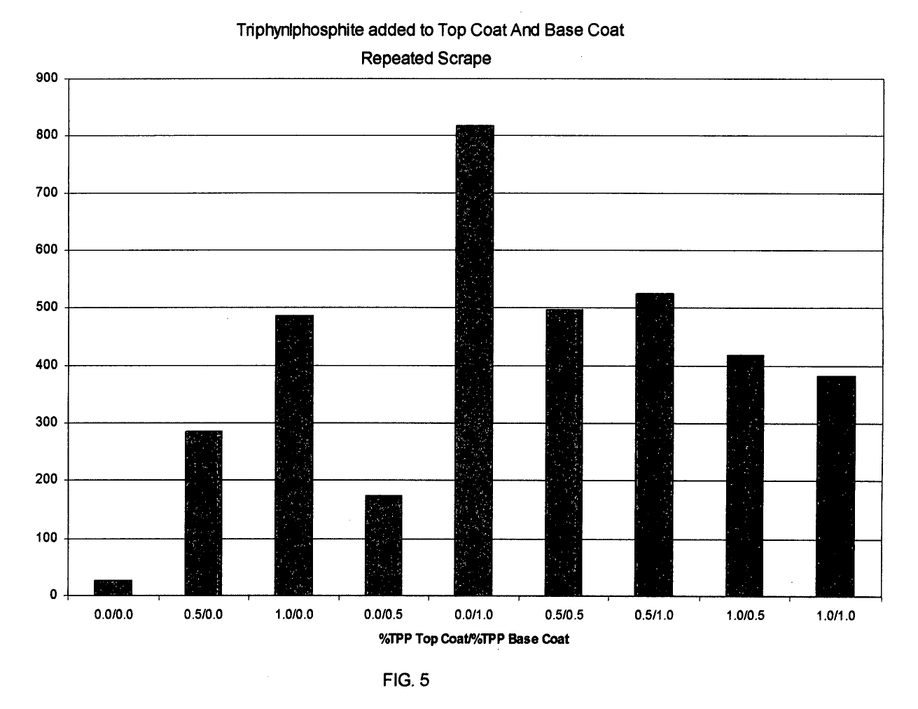

The repeated scrape test is a widely recognized and widely used measure of abrasion resistance for wire coatings. The test consists of a test wire suspended adjacent a pendulum having a needle attached at the distal end thereof. As the pendulum swings, the needle scrapes against the wire's outer coating. A defined load is exerted on the pendulum to provide a controlled force scraping the needle against the wire. For the working examples described herein, control and test wires were tested under a 700-gram load pendulum scraper for an 18 gauge (1 mm diameter) copper wire. The number of strokes (Repeated Scrapes) it took to wear through the coatings is recorded in the Tables below, and is shown in the graphs of FIGS. 1, 5, and 8. The greater number of strokes required before failure indicates a more abrasion resistant coating than a wire where failure occurs with a fewer number of strokes.

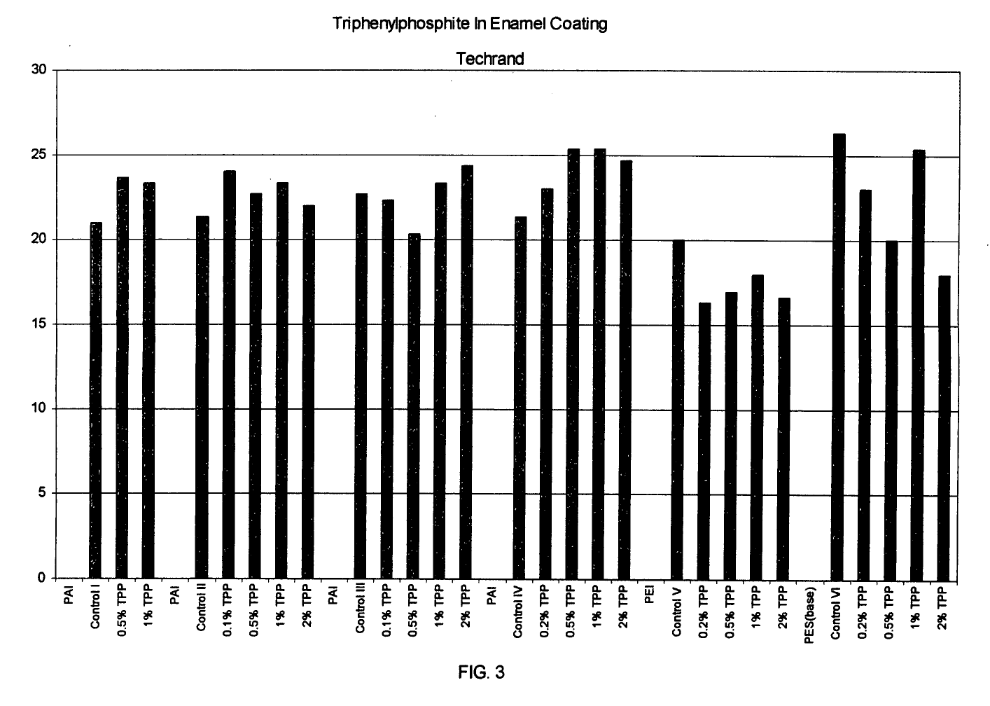

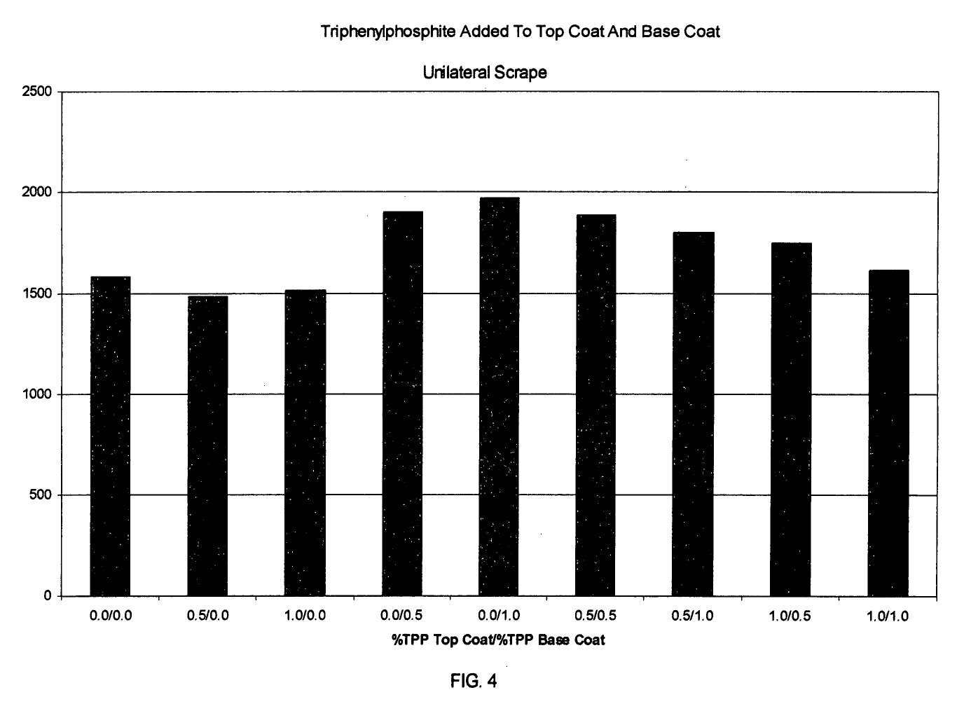

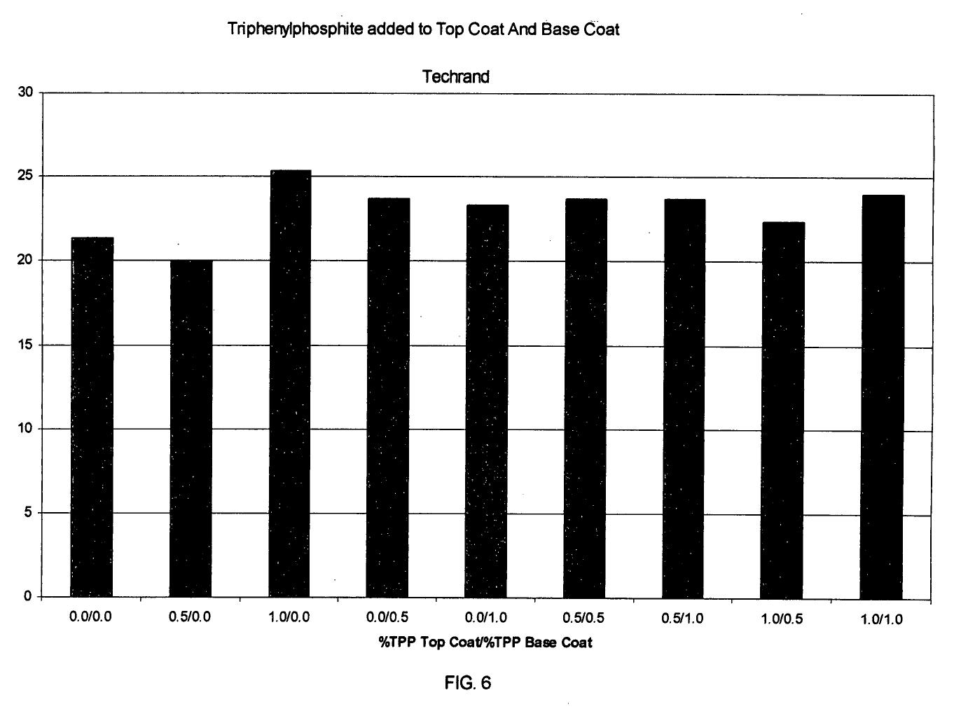

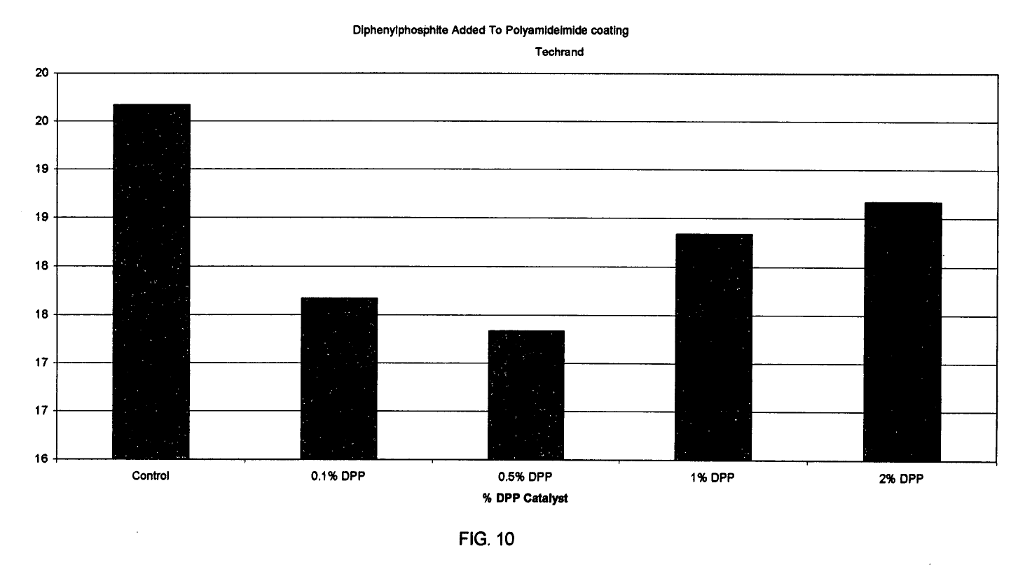

A techrand scrape (windability) test also was performed on the wires. This test determines both scrape abrasion and elongation resistance of a magnet wire's insulation. The techrand test involves winding one turn of a magnet wire on a mandrel. The mandrel is then driven (stroked) to travel in the longitudinal direction of the magnet wire, with a tension applied to the wire. A voltage of 1,500 volts was applied between the magnet wire and the mandrel and the number of strokes on the wire until three (3) or more faults occur was counted. This data is recorded in the Tables in the “Techrand” column and is shown in the graphs of FIGS. 3, 6 and 10.

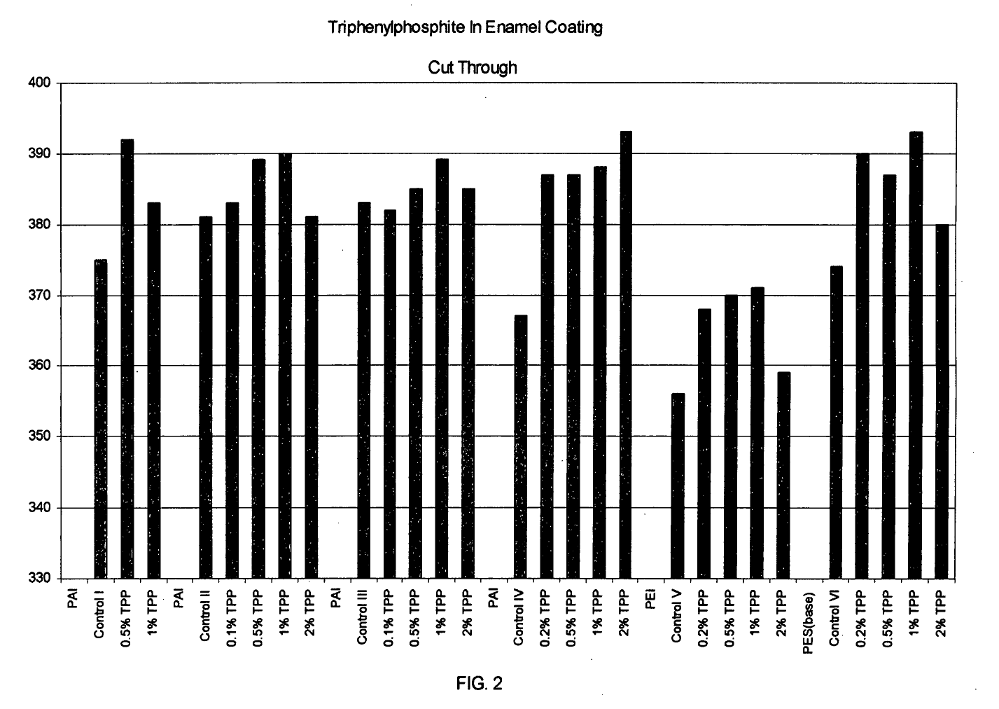

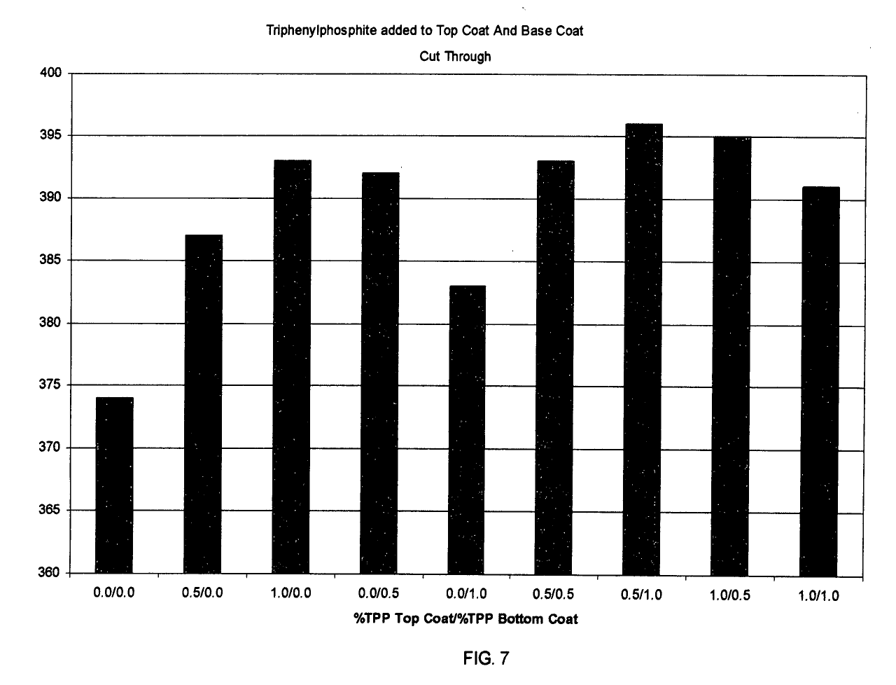

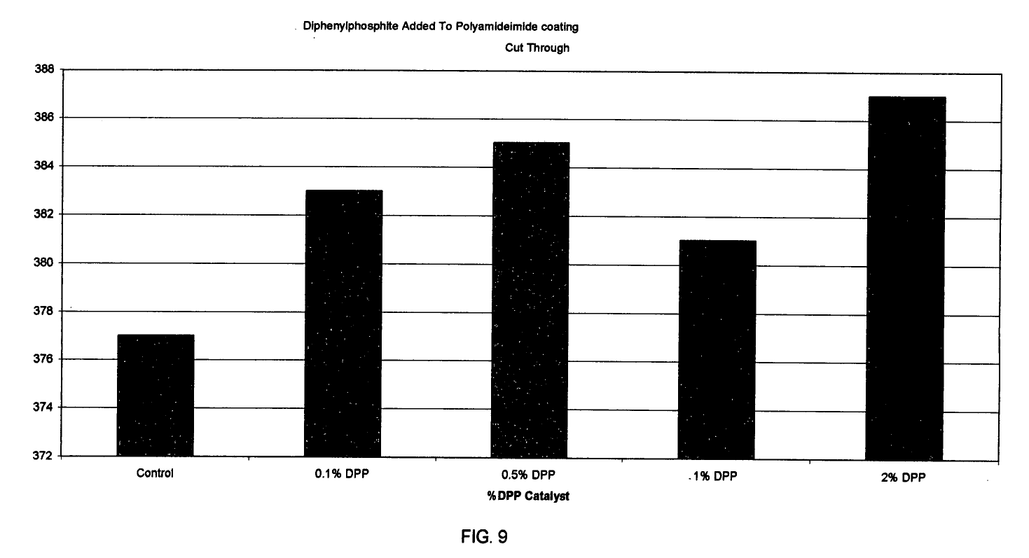

A thermoplastic flow, or cut through test was also performed. This test determines the capacity of the magnet wire's insulation to resist thermoplastic flow (softening) of the wire under the influence of temperature, load (pressure), and time. The specimen's test voltage was set at 110 volts AC, the test temperature's rate of rise was set at 5° C. per minute, and the loading was 975 g. Data from this test is recorded in the Tables in the “Cut Thru” column, and is shown in the graphs of FIGS. 2, 7 and 9.

Seven control wires, identified as Control Wires I-VII, were made as follows:

Control Wire I

A polyamideimide resin made from trimellitic anhydride (TMA) and methylenephenyldiisocyanate (MDI) was prepared according to procedures published, for example, in U.S. Pat. No. 3,541,038 which is incorporated herein by reference. The resulting resin solution was approximately 35% solids with a viscosity of about 800 cps at about 25° C. (about 77° F.). The solvent system was about 70:30 mixture of N-methylpyrrolidone and aromatic hydrocarbons.

The resultant coating was applied to an 18 AWG copper wire which was precoated with four passes of a polyester basecoat at a speed of about 30-40 feet per minute (fpm) in an oven having temperatures of between about 400-500° C. (about 752-932° F.). The total insulation build-up was approximately 2.8-3.3 mil in thickness with the polyamideimide topcoat being approximately 0.7-0.9 mil in thickness.

Control Wire II

Control Wire II was made identically to the way Control Wire I was made, except for the addition of about 3% (solids/solids) alumina powder into the polyamideimide coating. The typical size of the alumina powder was in the range of about 0.05-1 microns.

Control Wire III

Control Wire III was also made identically to the way Control Wire I was made, except for the addition of about 1% (solids/solids) polyethylene wax into the polyamideimide coating. The typical size of polyethylene wax was in the range of about 1-5 microns. The melting point of polyethylene wax used in making Control Wire III was approximately 120° C. (248° F.).

Control Wire IV

Control Wire IV was made identically to the way Control Wire I was made, except for the addition of about 1% (solids/solids) natural wax into the polyamideimide coating.

Control Wire V

A polyesterimide resin made from trimellitic anhydride (TMA), methylenephenyldiamine (MDA), trishydroxyethylisocyanuric acid (THEIC), terephthalic acid, and ethylene glycol was prepared according to procedures published, for example, in U.S. Pat. No. 3,426,098, which is incorporated herein by reference. The resulting resin solution was approximately 45% solids with a viscosity of 4000 cps at 25° C. (77° F.). The solvent system was approximately a 65:35 mixture of cresylic acid and aromatic hydrocarbons. The resin solution was catalyzed with tetrabutyltitanate in accordance with the published literature (including patents) for magnet wire, for example, as described in U.S. Pat. No. 3,426,098 referred to above.

The resultant coating was applied to an 18 AWG copper wire in six passes at a speed of about 30-40 fpm in an oven having temperatures of about 400-500° C. (about 752-932° F.). The total insulation build-up was approximately 2.8-3.3 mil thick.

Control Wire VI

A THEIC polyester resin made from terephthalic acid (TA), trishydroxyethylisocyanuric acid (THEIC), and ethylene glycol was prepared in accordance with procedures published, for example, in U.S. Pat. No. 3,342,780 which is incorporated herein by reference. The resulting resin solution was approximately 36% solids with a viscosity of about 700 cps at 25° C. (77° F.). The solvent system was approximately a 65:35 mixture of cresylic acid and aromatic hydrocarbons. The resin solution was catalyzed with tetrabutyltitanate in accordance with the published literature (including patents) for magnet wire, such as described in U.S. Pat. No. 3,342,780 referred to above.

The resultant coating was applied to an 18 AWG copper wire in four passes at a speed of about 30-40 fpm in an oven having temperatures of about 400-500° C. (about 752-932° F.). The total insulation build-up was approximately 2.4-2.6 mil thick. The wire was then topcoated with two passes of the Polyamideimide resin made for Control Wire I to a thickness of about 0.4-0.7 mil. Hence, Control Wire VI comprised a base coat of the THEIC polyester resin and a top coat of the noted polyamideimide resin.

Control Wire VII

A polyimide resin made from pyromellitic dianhydride (PMDA) and 4,4′-oxydianiline (ODA) was prepared according to published procedures such as described in U.S. Pat. No. 5,734,008 which is incorporated herein by reference. The resulting resin solution was approximately 15% solids with a viscosity of about 5500 cps at about 25° C. (about 77° F.). The solvent system was N-methylpyrrolidone.

The resultant coating was applied to an 18 AWG copper wire at a speed of about 30-40 fpm in an oven having temperatures of about 400-500° C. (about 752-932° F.). The total insulation build-up was approximately 2.2-2.3 mil thick.

The Control Wires are summarized in the Table I below:

TABLE I

| Control | | |
|---|---|---|
| Wire | Base Coat | Top Coat |
| I | THEIC polyester resin | polyamideimide resin |
| II | THEIC polyester resin | polyamideimide resin with 3% |
| | | (solids/solids) alumina powder |
| III | THEIC polyester resin | polyamideimide resin with 1% |
| | | (solids/solids) polyethylene wax |
| IV | THEIC polyester resin | polyamideimide resin with 1% |
| | | (solids/solids) natural wax |
| V | THEIC polyesterimide resin | |
| VI | THEIC polyester resin | polyamideimide resin |
| VII | polyimide resin | |

### WORKING EXAMPLES

### Triphenylphosphite

Varying amounts of triphenylphosphite (TPP) including 0.1% or 0.2%, 0.5%, 1% and 2% by weight were added to each control coating. Each control wire with triphenylphosphite was then tested and compared to each control wire with no triphenylphosphite to determine effects on abrasion resistance and thermoplastic flow (cut through). The following illustratively describes how the varying amounts of triphenylphosphite were added to the coating of each wire.

The resultant coating made for Control Wires I-IV was applied to 18 AWG copper wires. Each copper wire was pre-coated with four passes of a polyester basecoat at a speed of about 28-65 fpm in an oven having a temperature profile of about 400-500° C. (about 752-932° F.). Results were achieved with cure speeds of about 3040 fpm in an oven having a temperature of about 425° C. (about 797° F.). Wall-to-wall build, or thickness of the coated wire, was controlled to be within about 3.5 mils, and preferably within about 3.0-3.3 mils. The build ratio of topcoat to basecoat was controlled to be within about 15%-25% to about 75%-85%.

Control Wires I-IV, as well as the test wires of each percentage of triphenylphosphite, were subjected to the repeated scrape, techrand scrape, and thermoplastic flow tests. Their results are shown in Table II below. In each instance, the number of repeated and techrand scrapes increased dramatically as the amount of triphenylphosphite (TPP) in the coating was increased. This indicates that the triphenylphosphite catalyst increases the abrasion resistance of the coating. Thermoplastic flow (cut through) also rises between 5-23° C. for the samples with TPP as compared to the control. Improved cut through is a desirable property for high thermal endurance wires. Flex and dielectric breakdown remained virtually unchanged in the samples analyzed.

Control Wires V and VI, as well as the test wires of each percentage of triphenylphosphite, were also subjected to the repeated scrape, techrand scrape, and thermoplastic flow tests. Their results are shown in Table II. As before, compared to the control sample, the number of repeated scrapes increased dramatically as triphenylphosphite was added. Again this indicates that a triphenylphosphite catalyst increases the abrasion resistance of the coating. In these tests, cut through rose between 15-25° C. for the sample with TPP compared to the control. Flex and dielectric breakdown remained virtually unchanged in the samples analyzed.

Control Wire VII, as well as the test wires of each percentage of triphenylphosphite, were also subjected to the repeated scrape and techrand scrape tests, but not the thermoplastic flow tests. Their results are shown in Table III. As before, compared to the control sample, the number of repeated scrapes increased dramatically as triphenylphosphite was added. Again this indicates that phosphite catalysts, and in particular, a triphenylphosphite catalyst increases the abrasion resistance of the coating. Flex and dielectric breakdown remained virtually unchanged in the samples analyzed. Cut Through was not possible to measure with our equipment due to the high values achieved.

TABLE II

| | | Flex | | | | | Repeated | | |
|---|---|---|---|---|---|---|---|---|---|
| Catalyst | Additive | 0% snap | 20% snap | % to break | man at break | DE | Scrape | Cut Thru | Techrand |
| PAI | dual coat | | | | | | | | |
| Control I | — | OK 1X | OK 1X | 38% | OK 2X | 12.3 | 93 | 375 | 21 |
| 0.5% TPP | — | OK 1X | OK 1X | 38% | OK 2X | 12.6 | 175 | 392 | 24 |
| 1% TPP | — | OK 1X | OK 1X | 39% | OK 2X | 13.9 | 818 | 383 | 23 |
| PAI | dual coat | | | | | | | | |
| Control II | 3% alumina | OK 1X | OK 1X | 37% | OK 2X | 11.3 | 262 | 381 | 21 |
| 0.1% TPP | 3% alumina | OK 1X | OK 1X | 37% | OK 2X | 11.8 | 272 | 383 | 24 |
| 0.5% TPP | 3% alumina | OK 1X | OK 1X | 37% | OK 2X | 11.8 | 174 | 389 | 23 |
| 1% TPP | 3% alumina | OK 1X | OK 1X | 37% | OK 2X | 11.1 | 330 | 390 | 23 |
| 2% TPP | 3% alumina | OK 1X | OK 1X | 38% | OK 2X | 11.8 | 300 | 381 | 22 |
| PAI | dual coat | | | | | | | | |
| Control III | 1% PE wax | OK 1X | OK 1X | 36% | OK 1X | 9.7 | 211 | 383 | 23 |
| 0.1% TPP | 1% PE wax | OK 1X | OK 1X | 37% | OK 1X | 10.7 | 249 | 382 | 22 |
| 0.5% TPP | 1% PE wax | OK 1X | OK 1X | 36% | OK 3X | 9.3 | 175 | 385 | 20 |
| 1% TPP | 1% PE wax | OK 1X | OK 1X | 37% | OK 2X | 8.6 | 160 | 389 | 23 |
| 2% TPP | 1% PE wax | OK 1X | OK 1X | 37% | OK 2X | 9.2 | 199 | 385 | 24 |
| PAI | dual coat | | | | | | | | |
| Control IV | 1% wax | OK 1X | OK 1X | 39% | OK 1X | 12.3 | 158 | 367 | 21 |
| 0.2% TPP | 1% wax | OK 1X | OK 1X | 38% | OK 2X | 11.0 | 282 | 387 | 23 |
| 0.5% TPP | 1% wax | OK 1X | OK 1X | 38% | OK 1X | 11.3 | 197 | 387 | 25 |
| 1% TPP | 1% wax | OK 1X | OK 1X | 38% | OK 1X | 12.1 | 232 | 388 | 25 |
| 2% TPP | 1% wax | OK 1X | OK 1X | 38% | OK 2X | 11.2 | 161 | 393 | 25 |
| PEI | monolithic | | | | | | | | |
| Control V | — | OK 1X | OK 1X | 37% | OK 1X | 8.5 | 28 | 356 | 20 |
| 0.2% TPP | — | OK 1X | OK 1X | 38% | OK 1X | 8.6 | 93 | 368 | 16 |
| 0.5% TPP | — | OK 1X | OK 1X | 38% | OK 2X | 10.0 | 104 | 370 | 17 |
| 1% TPP | — | OK 1X | OK 1X | 38% | OK 2X | 9.7 | 142 | 371 | 18 |
| 2% TPP | — | OK 1X | OK 1X | 38% | OK 2X | 8.0 | 36 | 359 | 17 |
| PES(base) | Dual Coat | | | | | | | | |
| Control VI | — | OK 1X | OK 1X | 35% | OK 1X | 11.1 | 188 | 374 | 26 |
| 0.2% TPP | — | OK 1X | OK 1X | 33% | OK 1X | 10.3 | 115 | 390 | 23 |
| 0.5% TPP | — | OK 1X | OK 1X | 37% | OK 1X | 11.4 | 284 | 387 | 20 |
| 1% TPP | — | OK 1X | OK 1X | 37% | OK 1X | 11.4 | 485 | 393 | 25 |
| 2% TPP | — | OK 1X | OK 1X | 36% | OK 1X | 9.3 | 65 | 380 | 18 |

TABLE III

| | | | | | | | Repeated | | |
|---|---|---|---|---|---|---|---|---|---|
| PI | monolithic | 0% snap | 20% snap | % to break | man at break | DE | Scrape | Cut Thru | Techrand |
| Control VII | — | OK 1X | OK 1X | 37% | OK 2X | 10.5 | 14 | — | 28 |
| 0.2% TPP | — | OK 1X | OK 1X | 37% | OK 1X | 10.4 | 25 | — | 29 |
| 0.5% TPP | — | OK 1X | OK 1X | 37% | OK 2X | 11.0 | 82 | — | 25 |
| 1% TPP | — | OK 1X | OK 1X | 37% | OK 2X | 11.9 | 99 | — | 23 |
| 2% TPP | — | OK 1X | OK 1X | 37% | OK 1X | 12.7 | 58 | — | 16 |

The effect of a phosphorus catalyst in the basecoat and topcoat was also examined. This data is summarized in Table IV below. Compared to the control sample, the number of repeated scrapes increased dramatically as triphenylphosphite was added, further indicating that triphenylphosphite catalyst increases the abrasion resistance of the coating. The cut through (thermoplastic flow) rose between about 15-25° C. for the sample with TPP compared to the control. A modest improvement in techrand windability was also observed. Flex and dielectric breakdown remained virtually unchanged in the samples analyzed.

Further, the addition of the catalyst in the topcoat and basecoat improved the unilateral scrape resistance. The unilateral scrape resistance test determines the scrape abrasion resistance of magnet wire insulation. In performance of the test, a scrape head applies an increasing load to the magnet wire's insulation until a fault occurs. Scrape head speed is set at 16 inches per minute, and the wire sample is rotated through 0°, 120° and 240° after each test, thereby allowing 3 scrape tests per sample.

TABLE IV

| | | | | Flex | | | | | | | | |
|---|---|---|---|---|---|---|---|---|---|---|---|---|
| | TPP | | TPP | | | % to | man/ | | Repeated | Unilateral | | |
| Basecoat | Catalyst | Topcoat | Catalyst | 0% snap | 20% snap | break | break | DE | Scrape | Scrape | Cut Thru | Techrand |
| Polyester | 0.0% | PAI | 0.0% | OK 1X | OK 1X | 38% | OK 2X | 9.9 | 26 | 1583 | 374 | 21 |
| Polyester | 0.5% | PAI | 0.5% | OK 1X | OK 1X | 38% | OK 2X | 10.3 | 497 | 1883 | 393 | 24 |
| Polyester | 0.5% | PAI | 1.0% | OK 1X | OK 1X | 40% | OK 2X | 11.9 | 526 | 1800 | 396 | 24 |
| Polyester | 1.0% | PAI | 0.5% | OK 1X | OK 1X | 37% | OK 2X | 13.2 | 417 | 1750 | 395 | 22 |
| Polyester | 1.0% | PAI | 1.0% | OK 1X | OK 1X | 38% | OK 2X | 11.3 | 382 | 1617 | 391 | 24 |

### WORKING EXAMPLES

### Diphenylphosphite

Varying amounts of diphenylphosphite including 0.2%, 0.5%, 1% and 2% by weight were added to the control coating of Polyamideimide. The resultant control wire with diphenylphosphite was then tested and compared to the control wire with no diphenylphosphite to determine effects on abrasion resistance. The following describes how the varying amounts of diphenylphosphite were added to the coating of each wire.

The resultant coating was applied to separate 18 AWG copper wires, each of which was pre-coated with four passes of polyester basecoat, at a speed of about 28-65 fpm in an oven having a temperature profile of about 400-500° C. (about 752-932° F.). Results were achieved with cure speeds of about 30-40 fpm in an oven having a temperature of about 425° C. (about 797° F.). The wall-to-wall build or thickness of the coated wire was controlled to be within about 3.5 mils, and preferably within about 3.0-3.3 mils. The build ratio of topcoat to basecoat was controlled to be within about 15%-25% to about 75%-85%.

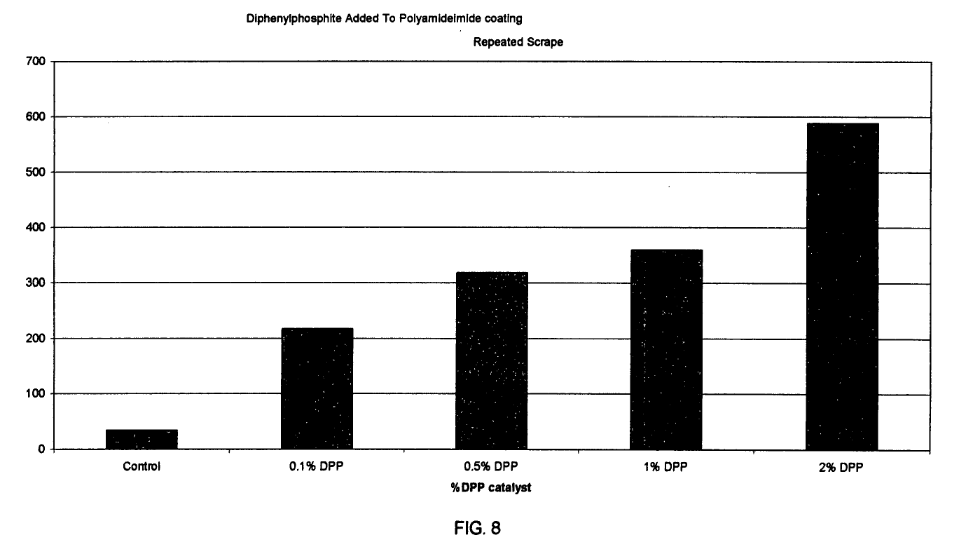

Control Wire VIII, as well as the test wires of each percentage of diphenylphosphite, were subjected to repeated scrape, techrand scrape, and thermoplastic flow tests. The test results are shown in Table V and illustrated in the graphs of FIGS. 8-10. Compared to the control sample, the number of repeated scrapes increased dramatically as diphenylphosphite was added. This indicates that a diphenylphosphite catalyst increases abrasion resistance of the coating. The cut through rose between 5-10° C. for the sample with DPP compared to the control.

TABLE V

| | Flex | | | | | Repeated | | |
|---|---|---|---|---|---|---|---|---|
| Catalyst | 0% snap | 20% snap | % to break | man at break | DE | Scrape | Cut Thru | Techrand |
| Control | OK 1X | OK 1X | 38% | OK 2X | 10.8 | 34 | 377 | 20 |
| 0.1% DPP | OK 1X | OK 1X | 39% | OK 2X | 11.6 | 217 | 383 | 18 |
| 0.5% DPP | OK 1X | OK 1X | 38% | OK 2X | 11.6 | 317 | 385 | 17 |
| 1% DPP | OK 1X | OK 1X | 39% | OK 2X | 10.8 | 359 | 381 | 18 |
| 2% DPP | OK 1X | OK 1X | 39% | OK 2X | 10.9 | 588 | 387 | 19 |

The foregoing shows that triphenylphosphite (TPP) and diphenylphosphite (DPP) catalysts increase the abrasion resistance of the polyamideimide coating. It is believed that any other phosphite catalyst would similarly enhance the abrasion resistance of the polyamideimide coating.

In view of the above, it will be seen that the several objects and advantages of the present invention have been achieved and other advantageous results have been obtained.

Having thus described the invention, what is claimed and desired to be secured by Letters Patent is:

1. An abrasion resistant coated wire comprising a conductive core and a coating circumferentially surrounding the core; the coating comprised of an electrical insulating resin cross-linked with a phosphorous catalyst.

2. The abrasion resistant coated wire of claim 1 wherein the resin is a polyamideimide, a THEIC polyesterimide, a THEIC polyester, or a polyimide.

3. The abrasion resistant coated wire of claim 1 wherein the coating includes an additive dispersed in the resin, the additive being chosen from the group consisting of inorganic or organic particulate material, wax, and combinations thereof.

4. The abrasion resistant coated wire of claim 3 wherein said particulate material is chosen from the group consisting of alumina, silica, boron nitride, PTFE and combinations thereof.

5. The abrasion resisting coated wire of claim 4 wherein the coating comprises approximately 3% alumina by weight.

6. The abrasion resistant coated wire of claim 3 wherein said wax is chosen from the group consisting of polyethylene, carnuba wax, bees wax, and combinations thereof.

7. The abrasion resistant coated wire of claim 6 wherein said coating comprises about 1% wax by weight.

8. The abrasion resistant coated wire of claim 1 wherein the coating resin comprises 0.001% to about 10% phosphorus catalyst by weight.

9. The abrasion resistant coated wire of claim 8 wherein the coating resin comprises about 0.1% to about 2% phosphorous catalyst by weight.

10. The abrasion resistant coated wire of claim 1 wherein the phosphorous catalyst is an aryl, arylalkyl or alkyl phosphorous based catalyst.

11. The abrasion resistant coated wire of claim 10 wherein the catalyst is chosen from the group consisting of diarylphosphites, triarylphosphites, triphenylphosphine, triphenylphosphine sulfide, alkyldiarylphosphites, dialkylarylphosphites and combinations thereof.

12. The abrasion resistant coated wire of claim 10 wherein the catalyst is chosen from the group consisting of triphenylphosphite, diphenylphosphite and combinations thereof.

13. The abrasion resistant coated wire of claim 1 wherein the coating is between about 2.2-3.5 mil thick.

14. The abrasion resistant coated wire of claim 1 wherein the coating comprises a base layer and a top layer; said base layer or top layer comprising one of a polyamideimide, a THEIC polyesterimide, a THEIC polyester and a polyimide coating; said base layer and top layer both comprising a phosphite.

15. A method of producing an abrasion resistant coated wire; the method comprising:
(a) providing a resin coating;
(b) applying said resin coating to a conductive core to produce a base coat; and
(c) curing said base coat;
said resin coating being formed by cross-linking one or more of a polyamideimide resin, a polyesterimide resin, a THEIC polyester resin, and a polyimide resin with a phosphorous based catalyist.

16. The method of claim 15 wherein the step of adding the phosphorous catalyst comprises about 0.1 to about 2% by weight of said resin.

17. The method of claim 15 wherein said phosphorous catalyst chosen from the group consisting of diarylphosphites, triarylphosphites, triphenylphosphine, triphenylphosphine sulfide, alkyldiarylphosphites, dialkylarylphosphites and combinations thereof.

18. The method of claim 17 wherein the arylphosphite is chosen from the group consisting of diarylphosphites, triarylphosphites and combinations thereof.

19. The method of claim 15 including a step of dispersing an additive in the resin, the additive being chosen from the group consisting of an inorganic or organic particulate material, wax, and combinations thereof.

20. The method of claim 19 said particulate material is chosen from the group consisting of alumina, silica, titanium dioxide, boron nitride, PTFE and combinations thereof.

21. The method of claim 20 wherein the coating comprises approximately 3% alumina by weight.

22. The method of claim 19 wherein said wax is chosen from the group consisting of polyethylene, carnuba wax, bees wax, and combinations thereof.

23. The method of claim 15 wherein the resin is applied to the core to produce a coating of about 2.2-3.5 mil thick.

24. The method of claim 15 including a step of applying a second coat of said resin about said base coat; and curing said second coat.

25. The method of claim 24 wherein said second coat of resin is applied after said base coat has been cured.

26. The method of claim 24 wherein the build ratio of said second coat to said base coat is about 15% to about 85%.
